(19) United States
(12) Patent Application Publication
(10) Pub. No.: US 2004/0120797 A1
(43) Pub. Date: Jun. 24, 2004

(54) Method and system for eliminating wafer protrusion

(75) Inventors: Scott David Paul, Plano, TX (US); Mark Edgar Montgomery, Frisco, TX (US); Mark Steven Johnson, Dallas, TX (US)

Correspondence Address: TEXAS INSTRUMENTS INCORPORATED, P O BOX 655474, M/S 3999, DALLAS, TX, 75265

(73) Assignee: Texas Instruments Incorpprated

(21) Appl. No.: 10/324,660

(22) Filed: Dec. 19, 2002

(51) Int. Cl. B65G 1/06

(52) U.S. Cl. 414/217.1

(57) ABSTRACT

A system for eliminating wafer protrusion includes one or more shelves stacked vertically in a stocker system. The system also includes one or more cassettes disposed on the shelves. The shelves support the one or more cassettes such that the cassettes are stacked vertically in the stocker system. Each cassette stores a plurality of wafers. One or more sensors are associated with the one or more cassettes. A wafer press is activated by the one or more sensors associated with the one or more cassettes. The wafer press is operable to apply a force to reposition one or more wafers protruding from the one or more cassettes.

### TECHNICAL FIELD OF THE INVENTION

This invention relates generally to the field of semiconductor device production and, more particularly, to a method and system for eliminating wafer protrusion in a semiconductor furnace.

### BACKGROUND OF THE INVENTION

During fabrication, semiconductor wafers are placed in furnaces where they undergo high temperature processes. Within the furnace, the semiconductor wafers are moved mechanically from one position to another. For example, semiconductor wafers may be repeatedly cycled between a boat for oxidation and film deposition processes to a stocker system where the wafers are stored between cycles. While in the stocker system, the wafers are stored in cassettes. The vibration of components within the furnace can cause the wafers to gradually slide or “walk” out of the cassettes. When the wafers protrude outside the cassettes by a predetermined amount, an alarm sensor may be triggered to signal that the wafers must be reset. To avoid the triggering of wafer protrusion alarms, conventional methods and techniques for the fabrication of semiconductor wafers include resetting the wafers by periodically removing the cassettes from the wafer furnace. After the wafers are reset in the cassettes, the cassettes are returned to the stocker system of the wafer furnace. The removal of the wafers from the stocker system and wafer furnace increases the manufacturing time associated with the wafers and, thus, decreases the overall throughput of the semiconductor device production process.

### SUMMARY OF EXAMPLE EMBODIMENTS

In accordance with the present invention, the disadvantages and problems associated with conventional techniques for the elimination of wafer protrusion in semiconductor furnaces are reduced or eliminated.

According to one embodiment of the present invention, a system for eliminating wafer protrusion is disclosed which includes one or more shelves stacked vertically in a stocker system. The system also includes one or more cassettes disposed on the shelves. The shelves support the one or more cassettes such that the cassettes are stacked vertically in the stocker system. Each cassette stores a plurality of wafers. One or more sensors are associated with the one or more cassettes. A wafer press is activated by the one or more sensors associated with the one or more cassettes. The wafer press is operable to apply a force to reposition one or more wafers protruding from the one or more cassettes.

Certain examples of the invention may provide one or more technical advantages. A technical advantage of one exemplary embodiment of the present invention is that wafer protrusion may be substantially reduced or eliminated without removing the wafers from the cassettes, in which they are stored. Another technical advantage is that wafers may be repositioned in the cassettes while in the stocker system. Because cassettes need not be removed from the stocker system and from the furnace generally, manufacturing time may be improved allowing more wafers to be fabricated. Another technical advantage is that the repositioning of the wafers while in the wafer furnace may create additional wafer furnace availability. A further technical advantage is that the defect density of produced wafers may be improved by reducing contamination associated with wafer handling and wafer breakage.

Other technical advantages may be readily apparent to one skilled in the art from the figures, descriptions and claims included herein. None, some, or all of the examples may provide technical advantages.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a wafer furnace that includes multiple wafer presses to reposition wafers protruding from vertically stacked cassettes within a stocker system; and

FIGS. 2A through 2E sequentially illustrate the use of a wafer press to reposition one or more wafers protruding from a cassette portion of a stocker system in a wafer furnace.

### DETAILED DESCRIPTION OF EXAMPLE EMBODIMENTS

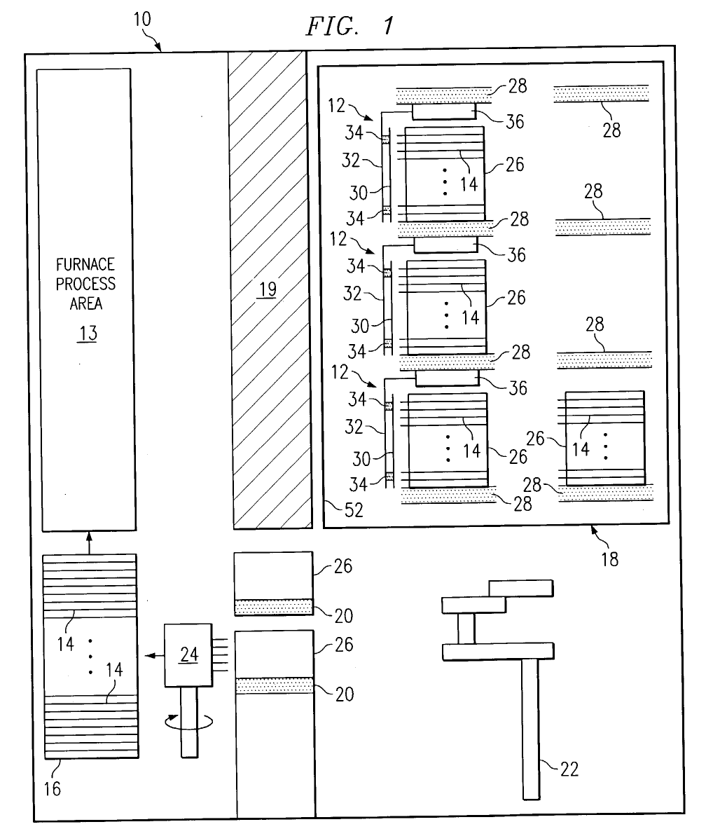

FIG. 1 illustrates a wafer furnace 10 that includes multiple wafer presses 12 configured to reposition wafers 14. Wafer furnace 10 includes a furnace process area 13, a boat 16, a stocker system 18, and one or more transfer stages 20. While undergoing high temperature processes in wafer furnace 10, such as oxidation and film deposition, cassette transfers 22 and wafer transfers 24 mechanically cycle semiconductor wafers 14 between various components of wafer furnace 10. In particular embodiments, wafer furnace 10 is a Tokyo Electron furnace. For example, wafer furnace 10 may comprise a TEL Alpha 8SE furnace.

Although the terms “wafers” and “dummies” are used interchangeably in this description, it is recognized that a wafer is a thin polished slice of crystal material sliced from a crystal cylinder grown for the purpose of semiconductor fabrication. According to one typical fabrication technology, a wafer may be eight inches in diameter and provides the foundation on which a semiconductor device may be created. The semiconductor device may be created on the surface of the wafer using a variety of techniques and procedures, such as layering, photolithographic patterning, doping through implantation of ionic impurities, and heating. A dummy takes the place of a production wafer and is typically comprised of an unprocessed wafer of the same starting material as production wafers. The starting material may comprise silicon, gallium arsenide, or other suitable substrate material. Despite these differences, the terms “dummies” and “wafers” may be used interchangeably for purposes of this description as the operations of the system and methods of the present invention will operate equally on wafers or dummies.

Wafer furnace 10 includes one or more boats 16 configured to hold multiple wafers 14. Wafers 14 may be stored in boat 16 during cycles in furnace process area 13. Boat 16 may be comprised of quartz or silicon carbide depending on the semiconductor processes being used to manufacture wafers 14. Boat 16 of wafer furnace 10 includes multiple slots to horizontally store stacked wafers 14. For example, boat 16 may include 170 slots. During typical fabrication processes, the slots of boat 16 may not be filled entirely with production wafers. To ensure proper heat transfer and gas flow through boat 16, dummies are placed in the remaining slots. Thus, a boat 16 configured to include 170 slots may store any combination of 170 wafers and dummies. If, for example, a 170 slot boat 16 contains 134 production wafers, the remaining 36 slots may be filled with dummy wafers. Dummy wafers 14 cycle through various components of wafer furnace 10 for extended periods of time. In various embodiments, a dummy wafer may remain in wafer furnace 10 for as much as a year or more.

Between cycles in boat 16 and furnace process area 13, wafers 14 are stored in a stocker system 18 of wafer furnace 10. In various embodiments, wafer furnace 10 may be configured such that stocker system 18 and furnace process area 13 are separated by divider 19. Divider 19 may comprise an insulated wall designed to protect wafers 14 stored in stocker system 18 from excess heat generated by furnace process area 13 or other components of wafer furnace 10. In stocker system 18, a plurality of wafers 14 may be stored in one or more cassettes 26 stacked vertically on shelves 28 of stocker system 18. Cassettes 26 may comprise any apparatus suitable for storing wafers 14 while undergoing or awaiting isolated semiconductor device production processes in furnace process area 13 and/or other components of wafer furnace 10. For example, cassettes 26 and stocker system 18 may store wafers 14 in a wafer furnace 10 while wafers 14 await or undergo various high temperature processes such as oxidation or annealing. Although the description of the operations of the system and method of the present invention are described as being applied to wafers 14 stored in stocker system 18 of wafer furnace 10, it is generally recognized that the disclosed principles will operate equally on wafers 14 stored in other components of wafer production technology both external and internal to wafer furnace 10. For example, wafers 10 may be stored in cassettes 26 while undergoing cleaning or washing processes.

Each cassette 26 includes multiple slots for holding wafers 14. For example, cassette 26 may include twenty-five slots for storing twenty-five wafers 14. In the illustrated embodiment, each cassette 26 is supported by a shelf 28 of stocker system 18. Even when properly placed in cassette 26, wafers 14 may protrude slightly from one side of cassette 26. Wafers 14 commonly protrude from cassette 26 by approximately one millimeter. While being transported between components of wafer furnace 10, however, wafers 14 may be displaced unintentionally and begin to further protrude from cassette 26.

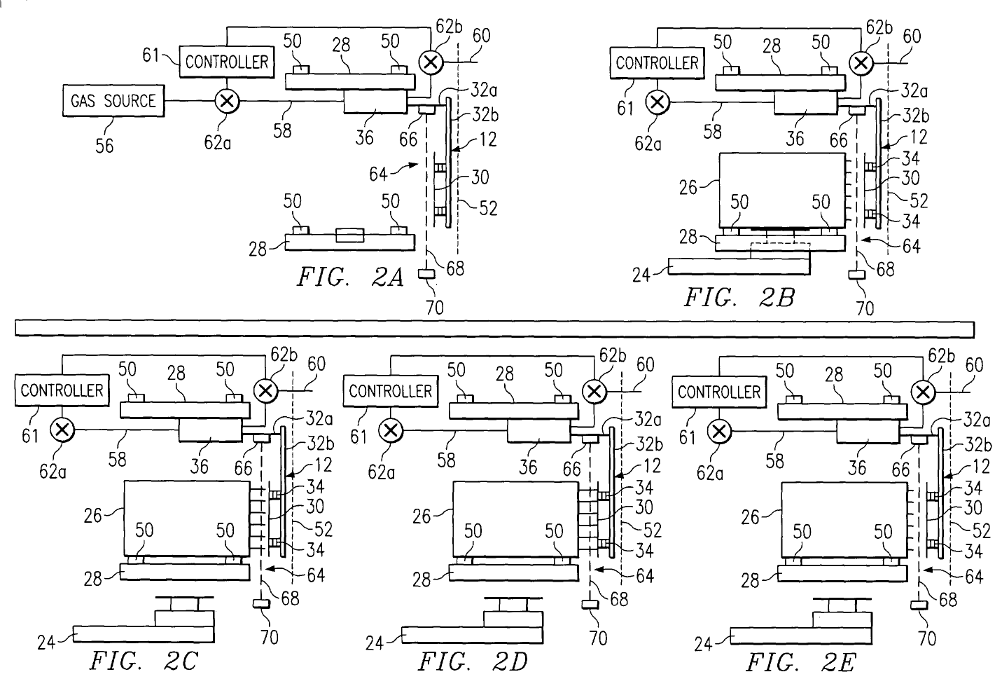

According to one embodiment of the present invention, wafer furnace 10 includes one or more wafer presses 12. Wafer presses 12 operate to remedy wafer protrusion by repositioning wafers 14 in cassettes 26 while cassettes 26 are stored in stocker system 18. As will be described in greater detail with regard to FIGS. 2A through 2E, each wafer press 12 may include a press plate 30 coupled to an extending arm 32. Press plate 30 may be rigidly or flexibly coupled to extending arm 32. For example, springs 34 may couple press plate 30 and extending arm 32 to buffer the force wafer press 12 exerts on protruding wafers 14 and cassette 26. Extending arm 32 couples wafer press 12 to a cylinder 36. Cylinder 36 may be attached to shelf 28 or another component within wafer furnace 10. In particular embodiments, wafer furnace 10 may be configured to include a wafer press 12 associated with each cassette 26 stored in stocker system 18. In other embodiments, wafer furnace 10 may be configured to allow a single wafer press 12 to reposition protruding wafers 14 stored in multiple cassettes 26 of stocker system 18.

In operation, wafers 14 are placed in wafer furnace 10 to undergo high temperature semiconductor fabrication processes such as oxidation, film deposition, or annealing. While undergoing these example thermal processes, wafers 14 are stored horizontally in boat 16. After a cycle in boat 16 is complete, wafer transfer 24 removes wafers 14 from boat 16 and transports wafers 14 to transfer stage 20. At transfer stage 20, wafers 14 are placed in cassettes 26. Cassette transfer 22 then transports the wafer-containing cassettes 26 to stocker system 18. Wafers 14 remain in stocker system 18 until wafers 14 must undergo further fabrication processing in boat 16 or in other components of wafer furnace 10. As one example, a wafer 14 may be transported in cassette 26 from stocker system 18 to transfer stage 20 where the wafer 14 is removed from cassette 26 and loaded in boat 16. The wafer may remain in boat 16 for thirty minutes while an oxide is grown on the surface of the wafer 14. The wafer may then be unloaded from boat 16 and returned to transfer stage 20 where the wafer is placed once again in cassette 26 to be returned to stocker system 18.

When properly stored in cassette 26, wafers 14 protrude slightly from one side of cassette 26. For example, wafers 14 may protrude from cassette 26 by approximately one millimeter. As wafers 14 are cycled through wafer furnace 10, wafers 14 may be unintentionally displaced such that one or more wafers 14 protrudes an undesirable amount from cassette 26. This displacement may be referred to as “wafer walk” and may occur as the result of many different factors. For example, wafer walk may occur when wafers 14 are returned to cassettes 26 after a cycle in boat 16. Although wafers 14 are returned to cassettes 26 before being stored in stocker system 18, the mechanical or robotic transporting of wafers 14 within wafer furnace 10 may result in the improper placement of one or more wafers 14 in slots of cassettes 26. The improper placement of wafers 14 in cassette 26 may result in an undesirable protrusion of wafers 14 from cassette 26. As another cause of wafer walk, various tools and components in wafer furnace 10 may vibrate causing wafers 14 to protrude more than desirable. If wafers 14 are not repositioned within cassettes 26, wafer walk may ultimately cause damage to wafers 14 or breakage. Wafer walk may also cause other systems within wafer furnace 10 to malfunction.

As will be described in greater detail with regard to FIGS. 2A through 2E, wafer furnace 10 may include one or more sensors to activate wafer presses 12. In one embodiment, a sensor may be triggered when a cassette 26 is placed on shelf 28 in stocker system 18. In another embodiment, the sensor may be activated when one or more wafers 14 extend a predetermined distance outside of cassette 26 while cassette 26 is stored in stocker system 18. If for example the allowable tolerance for wafer protrusion is up to approximately three millimeters, the sensor may be triggered when one or more wafers 14 extends more than three millimeters outside of cassette 26. In various embodiments, the triggering of the sensor activates one or more wafer presses 12. Activated wafer presses 12 then operate to reset protruding wafers 14. Wafer presses 12 apply a horizontal force to wafers 14 that presses wafers 14 into the proper position within cassette 26. A technical advantage of the described system is that wafer presses 12 allow the repositioning of wafers 14 without requiring that wafers 14 or cassettes 26 be removed from stocker system 18 or from wafer furnace 10.

FIGS. 2A through 2E sequentially illustrate the use of wafer press 12 to reposition one or more wafers 14 protruding from a cassette 26 stored in stocker system 18. FIGS. 2A through 2E illustrate only that portion of stocker system 18 that is configured to store a single cassette 26. As described with regard to FIG. 1, however, stocker system 18 may be configured to store multiple cassettes 26 and each cassette 26 may hold multiple wafers 14.

FIG. 2A illustrates stocker system 18 before a cassette 26 is transferred into stocker system 18. The illustrated portion of stocker system 18 includes multiple shelves 28, one or more cassette sensors 50, and a wafer press 12. Each shelf 28 of stocker system 18 is configured to support at least one cassette 26. Cassette sensors 50 are located on the surface of shelves 28 and may include optical sensors, pressure sensors, weight sensors, or other mechanisms for detecting the placement of a cassette 26 on shelf 28. In particular embodiments, stocker system 18 may include four cassette sensors 50 positioned on each shelf 28. The four cassette sensors 50 may be positioned such that each of the four corners of a properly placed cassette 26 activates a cassette sensor 50. In other embodiments, shelf 28 may include fewer cassette sensors 50 positioned beneath the front and/or back corners of a properly placed cassette 26.

As described with regard to FIG. 1, wafer press 12 includes press plate 30 extending in a vertical direction proximate to a first wall 52 of wafer furnace 10. Press plate 30 is perpendicular to shelves 28. Press plate 30 is comprised of a metal or other substantially rigid material capable of resisting the high temperatures of wafer furnace 10. Wafer press 12 is coupled to cylinder 36. Cylinder 36 receives gas from a gas source 56 through line 58 as controlled by valve 62a. Cylinder 36 releases gas through line 60. Although gas source 56 may supply gas only to cylinder 36, it is also contemplated that gas source 56 supplies gas to other components of wafer furnace 10 as well. The gas supplied by gas source 56 may include any appropriate gas for cylinder 36. In particular embodiments, the gas supplied by gas source 56 may include processed or non-processed Nitrogen gas.

The pressure, as may be measured in pounds per square inch or another appropriate measure, of gas within cylinder 36 controls the location and movement of wafer press 12. For example, transferring gas from gas source 56 to cylinder 36 via line 58 may increase the pressure in cylinder 36. Similarly, removing gas from cylinder 36 via line 60 may decrease the pressure in cylinder 36. If gas removed from cylinder 36 would damage components of wafer furnace 10, line 60 may extend through a wall in the wafer furnace 10 such that the gas is vented external to wafer furnace 10. The increase and decrease in pressure within cylinder 36 is controlled by a controller 61 communicating with the two valves 62. Controller 61 regulates the flow rate of gas through valves 62. When opened by controller 61, valve 62a allows the passage of gas from gas source 56 to cylinder 36, which increases the pressure in cylinder 36. Conversely, when opened by controller 61, valve 62b allows the venting of gas from cylinder 36, which decreases the pressure in cylinder 36.

In operation, an increase or decrease in pressure within cylinder 36 causes wafer press 12 to move. For example, the pressure in cylinder 36 may be generally maintained at a higher pressure. The higher pressure in cylinder 36 causes extending arm 32a to be generally maintained in an extended position such that press plate 30 is proximate to first wall 52. To prevent wafer protrusion, it may be desirable to periodically or routinely move press plate 30 toward cassette 26 to ensure that wafers 14 are properly positioned in cassette 26. Accordingly, controller 61 may open valve 62b and the pressure in cylinder 36 may be decreased as gas is removed from cylinder 36 and vented via line 60. As gas is removed from cylinder 36, a vacuum in cylinder 36 may decrease the length of extending arm 32a causing press plate 30 to move toward cassette 26 and away from first wall 52. As press plate 30 is moved toward cassette 26, press plate 30 contacts protruding wafers 14 and applies a force to wafers 14 pressing the wafers 14 into a proper position within cassette 26. After pressing wafers 14, the pressure in cylinder 36 may be increased to move press plate 30 back to its original pre-activation position. Controller 61 may open valve 62a allowing gas to be added to cylinder 36 and the pressure in cylinder 36 increased. The increase in gas pressure within cylinder 36 causes the length of extending arm 32a to be increased. As a result, press plate 30 moves away from shelf 28 and toward first wall 52.

In particular embodiments, the increase or decrease in pressure within cylinder 36 may be triggered by cassette sensors 50. As described above, cassette sensors 50 may be located on the surface of shelves 28. For example, four cassette sensors 50 may be positioned on each shelf 28 such that each of the four corners of a properly placed cassette 26 activates a cassette sensor 50. Alternatively, shelf 28 may include fewer cassette sensors 50 positioned on shelf 28 such that it is beneath some portion of cassette 26. The placement of a cassette 26 on shelf 28 by cassette transfer 22 activates the one or more cassette sensors 50. Cassette sensors 50 then send a signal to controller 61 indicating that a cassette sensor 50 has been triggered and that wafer press 12 should be activated. In response, controller 61 actuates valve 62b, and the pressure in cylinder 36 is decreased. As discussed above, the decrease in pressure causes wafer press 12 to move toward cassette 26.

In alternative embodiments, the increase or decrease in pressure within cylinder 36 may be triggered by a wafer protrusion detector 64. Thus, controller 61 may receive a signal from wafer protrusion detector 64 and actuate valves 62, accordingly. In particular embodiments, detector 64 comprises a transmitter 66, which transmits an optical beam 68 between cassettes 26 and first wall 52. Detector 64 also comprises a receiver 70 that receives the optical beam 68 and detects the absence of an optical beam 68 when the optical beam is disrupted. As was described with regard to FIG. 1, vibration within wafer furnace 10 may cause wafers 14 stored in cassettes 26 to slide or walk. Wafers 14 may begin to protrude outside the perimeter of cassette 26 beyond allowable limits. As one or more wafers 14 walk into the line of optical beam 68, the path of optical beam 68 is disturbed and the detector 64 is triggered. Receiver 70 registers the disturbance of optical beam 68 and sends a signal to controller 61 indicating that the detector 64 has been triggered. In response, controller 61 actuates valve 62b, and the pressure in cylinder 36 is decreased. As discussed above, the decrease in pressure causes wafer press 12 to move toward cassette 26 and away from first wall 52. In particular embodiments, transmitter 66 may be positioned to transmit optical beam 68 such that when one or more wafers 14 walk at least three millimeters beyond cassette 26 detector 64 is triggered.

Although FIGS. 2A through 2E are shown as including a detector 64 that transmits and receives an optical beam 68, controller 61 and detector 64 may include any mechanism for periodically adjusting the position of wafer press 12. For example, controller 61 may include a timer that actuates valves 62a and 62b to increase or decrease the pressure in cylinder 36, respectively, at pre-selected time intervals. If, for example, it is desirable to reposition wafers 14 in cassettes 26 after every ten runs and a run typically takes fifteen minutes, controller 61 may trigger valves 62 to decrease and increase the pressure in cylinder 36 every one-hundred and fifty minutes. In this embodiment, detector 64 may be unnecessary. Similarly, where wafer press 12 is activated by cassette sensors 50 when cassette 26 is placed on shelf 28, detector 64 may also be unnecessary.

In the illustrated embodiment, a cylinder 36 is coupled to the underside of each shelf 28, and each cylinder 36 is associated with a corresponding wafer press 12. Thus, wafer press 12 that is coupled to a particular cylinder 36 repositions wafers 14 located in the cassette 26 placed on the shelf 28 immediately below the particular cylinder 36. Where cylinder 36 is attached to the underside of shelf 28, wafer press 12 may include a substantially L-shaped extending arm 32 coupling press plate 30 to cylinder 36. Extending arm 32 may include a first portion 32a that couples to cylinder 36 and extends horizontally toward first wall 52. In particular embodiments, it may be desirable to locate wafer press 12 in an appropriate location to prevent wafer press 12 from interfering with the transportation of cassettes 26 within wafer furnace 10. Extending arm 32 may also include a second portion 32b that extends vertically from first portion 32a parallel to first wall 52. Second portion 32b of extending arm 32 spans the distance between two shelves 28.

Where extending arm 32 is substantially L-shaped, press plate 30 is coupled to second portion 32b of extending arm 32. One or more springs 34 may couple press plate 30 to second portion 32b of extending arm 32. Springs 34 may comprise any elastic device that regains its shape after compression or extension. For example, springs 34 may include a helical wire spring, a disk spring, a spiral spring, or any other spring 34 suitable for coupling press plate 30 to second portion 32b. Although wafer press 12 illustrated in FIGS. 2A through 2E includes a press plate 30 coupled to extending arm 32 of wafer press 12 with springs 34, it is also contemplated that press plate 30 may be coupled to extending arm 32 in any other manner whether rigid or flexible. Springs 34 buffer the force wafer press 12 exerts on protruding wafers 14 and cassette 26. Additionally, springs 34 increase the overall tolerance of the system with respect to the movement of wafer press 12. For example, in particular embodiments, the starting position of press plate 30 may be approximately five millimeters from cassette 26. If the optimum position of wafers 14 includes wafers 14 protruding approximately one millimeter from cassette 26, wafer press 12 may be configured to move four millimeters toward cassette 26. The presence of springs 34 coupling press plate 30 to wafer press 12, however, increases the permissible deviation from the specified dimensions.

Although wafer press 12 has been described as including a substantially L-shaped extending arm 32 coupling wafer press 12 to a cylinder 36 attached to the underside of the immediately above shelf 28, it should be understood that various changes, alterations, substitutions, and modifications can be made to wafer press 12. For example, extending arm 32 need not be substantially L-shaped. Extending arm 32 may include only a vertically extending portion, such as second portion 32b, that couples wafer press 12 directly to cylinder 36. In this embodiment, cylinder 36 may extend horizontally from beneath shelf 28 and span a desired distance between shelf 28 and first wall 52. Extending arm 32b may couple directly to cylinder 36 and extend vertically parallel to first wall 52. Where extending arm 32 is not substantially L-shaped, detector 64 may couple directly to cylinder 36 or any other appropriate component within wafer furnace 10.

In another embodiment, cylinder 36 may attach to a component other than shelf 28. For example, cylinder 36 may attach to another component of stock system 18, to another component within wafer furnace 10, or to a component external to wafer furnace 10. In such embodiments, extending arm 32 may be substantially L-shaped, substantially straight, or of any other shape suitable for coupling to wafer press 12 and cylinder 36. In embodiments where cylinder 36 is external to stocker system 18, extending arm 32 may also be partially external to stocker system 18 and pass through a wall of stocker system 18. In embodiments where cylinder 36 is external to wafer furnace 10, extending arm 32 may also be partially external to wafer furnace 10 and pass through a wall of wafer furnace 10.

In still another embodiment, a single cylinder 36 may operate to control the movement of multiple wafer presses 12. The pressure in the single cylinder 36 may be increased or decreased to activate multiple wafer presses 12. Where wafer furnace 10 includes only a single cylinder 36, cylinder 36 may be attached to any component or wall of wafer furnace 10 that is proximate to stocker system 18. For example, cylinder 36 may attach to a top wall of wafer furnace 10 and extending arm 32b may extend vertically the entire length of stocker system 18. Multiple press plates 30 may attach to extending arm 32b, and each press plate 30 may correspond with a cassette 26 stored in stocker system 18. Further alterations may include a single press plate 30 repositioning protruding wafers 14 in all cassettes 26 of stocker system 18 or multiple press plates 30, in which each press plate 30 repositions protruding wafers in two or more cassettes 26. For example, a single press plate 30 may attach to extending arm 32b and extend vertically the entire length of stocker system 18. By extending the length of stocker system 18, the single press plate 30 may reposition wafers 14 protruding from multiple cassettes 26 stored in stocker system 18. As a further modification, the functionality of extending arm 32 and press plate 30 may be combined in a single component of wafer press 12. For example, rather than including both an extending arm 32 and a press plate 30 coupled to the extending arm 32, press plate 30 may couple directly to cylinder 36. By increasing or decreasing the pressure in cylinder 36, the location of press plate 30 may be directly adjusted. As described above, detector 64 may trigger the change in pressure within cylinder 36. Where wafer press 12 does not include extending arm 32, detector 64 may be attached directly to cylinder 36 or any other component of wafer furnace 10 proximate to stocker system 18.

FIG. 2B illustrates cassette 26 as cassette transfer 22 is placing cassette 26 in stocker system 18. Cassette transfer 22 includes any apparatus for mechanically or robotically moving cassettes 26 from one component to another component in wafer furnace 10. A cassette transfer 22 configured to transport cassettes 26 may contact the underneath side of cassette 26 such that cassette 26 is approximately centered on cassette transfer 22. Cassette transfer 22 transports cassette 26 to stocker system 18 and places cassette 26 on shelf 28. To properly position cassette 26 on shelf 28, cassette transfer 22 may place cassette 26 on cassette sensors 50. The underside of cassette 26 may include grooves or other protrusions that correspond to cassette sensors 50 on shelf 28. As described above with regard to FIG. 2A, cassette sensors 50 may be positioned on shelf 28 such that each of the four corners of cassette 26 are supported by a cassette sensor 50. Alternatively, few cassette sensors 50 may be used to determine the proper placement of cassette 26 on shelf 28. Upon properly positioning cassette 26 on cassette sensors 50, cassette transfer 22 releases cassette 26 and moves out of stock system 18.

In particular embodiments, the placement of cassette 26 on cassette sensors 50 may trigger an increase or decrease in pressure within cylinder 36. As described above, the placement of a cassette 26 on shelf 28 by cassette transfer 22 may activate the one or more cassette sensors 50. Cassette sensors 50 may then send a signal to controller 61 indicating that a cassette sensor 50 has been triggered and that wafer press 12 should be activated. In response, controller 61 may actuate valve 62b, and the pressure in cylinder 36 may be decreased. As discussed above, the decrease in pressure causes wafer press 12 to move toward cassette 26. In alternative embodiments, a detector 64 that includes an optical beam 68 may be used to detect wafer protrusion in one or more cassettes. FIG. 2C illustrates cassette 26 after vibration or some other cause within wafer furnace 10 causes wafers 14 to protrude beyond optical beam 68. As previously described with regard to FIG. 1, wafers 14 properly positioned in the slots of cassette 26 may protrude from cassette 26 by approximately one millimeter or less. Vibration of tools within wafer furnace 10, however, may cause wafers 14 to gradually slide or “walk” such that wafers 14 further protrude from cassette 26. As described above with regard to FIG. 2A, wafer press 12 may include a detector 64 for detecting when wafers 14 walk a predetermined amount outside of cassette 26. Detector 64 includes a transmitter 66 configured to transmit optical beam 68 that is detected by receiver 70. Wafer press 12 may be configured to vertically transmit optical beam 68 approximately three to five millimeters from cassette 26. In this particular example, wafers 14 protruding more than three millimeters outside of cassette 26 trigger detector 64. The triggering of detector 64 may cause a decrease in gas pressure in cylinder 36. For example, receiver 70 may send a signal to controller 61 indicating that detector 64 has been triggered. Upon receiving the signal, controller 61 may activate valve 62b to remove gas from cylinder 36 and vent the gas via line 60.

FIG. 2D illustrates stocker system 18 as the wafer press 12 resets the protruding wafers 14 into the proper position in cassette 26. As described above, wafer press 12 may be activated by cassette sensors 50, detector 64, or any another system for periodically or routinely triggering a decrease in pressure within cylinder 36. A decrease in pressure within cylinder 36 may cause wafer press 12 to move toward protruding wafers 14. Where, for example, controller 61 and detector 64 are configured to trigger movement of wafer press 12 after wafers 14 protrude more than three millimeters beyond cassette 26, the pressure in cylinder 36 may be decreased to allow press plate 30 of wafer press 12 to move toward cassette 26 until press plate 30 contacts protruding wafers 14 and wafers are properly repositioned in cassette 26. In particular embodiments, wafers 14 are properly positioned in cassette 26 when wafers 14 protrude from cassette 26 only by approximately one millimeter or less.

FIG. 2E illustrates stocker system 18 after wafer press 12 has reset protruding wafers 14 by pressing wafers 14 into the proper position. After pressing wafers 14 into the proper position in the slots of cassette 26, controller 61 may activate valve 62a causing the pressure in cylinder 36 to increase. Pressure may be increased by transferring gas from gas source 56 to cylinder 36. An increase in pressure may cause extending arm 32 to move away from cassette 26 and toward first wall 52. Thus, wafer press 12 may be reset to its position proximate to first wall 52. Wafer press 12 may remain in this position until wafers 14 protruding beyond optical beam 68 again trigger detector 64.

The preceding description outlining the use of wafer press 12 to reset or reposition wafers 14 stored in cassettes 26 of stocker system 18 illustrates only an example method of operation, and wafer press 12 contemplates the resetting of protruding wafers 14 using any suitable techniques and elements for doing so within wafer furnace 10. Therefore, many of the steps described with regard to FIGS. 2A through 2E may take place simultaneously and/or in different orders than as described. In addition, wafer furnace 10 may use methods with additional steps, fewer steps, and/or different steps, so long as the method of operation remains appropriate.

Although the present invention has been described in detail, it should be understood that various changes, alterations, substitutions, and modifications can be made to the teachings disclosed herein without departing from the spirit and scope of the present invention which is solely defined by the appended claims.

What is claimed is:

1. A system for eliminating wafer protrusion, comprising:
one or more shelves stacked vertically in a stocker system;
one or more cassettes disposed on the shelves, the shelves supporting the one or more cassettes such that the cassettes are stacked vertically in the stocker system, each cassette storing a plurality of wafers;
one or more sensors associated with one or more cassettes;
a wafer press activated by the one or more sensors associated with the one or more cassettes, the wafer press operable to apply a force to reposition one or more wafers protruding from the one or more cassettes.

2. The system of claim 1, wherein the wafer press is coupled to a cylinder, the system further comprising a controller operable to trigger a pressure change in the cylinder to change the location of the wafer press.

3. The system of claim 2, wherein an increase in pressure moves the wafer press away from the one or more cassettes and a decrease in pressure moves the wafer press toward the one or more cassettes, the wafer press operable to apply a force to the wafers protruding from the one or more cassettes, when the pressure is decreased.

4. The system of claim 2, wherein the cylinder includes compressed Nitrogen gas.

5. The system of claim 2, wherein the wafer press comprises:
an extending arm coupling the wafer press to the-cylinder; and
a press plate coupled to the extending arm with one or more springs, the press plate configured to apply a force in the horizontal direction to reposition the wafers protruding from the one or more cassettes.

6. The system of claim 1, wherein the wafer press is activated when the one or more sensors detect the placement of a cassette on an associated shelf.

7. The system of claim 1, wherein the wafer press is activated when the one or more sensors detect one or more wafers protruding a predetermined distance outside the one or more cassettes.

8. The system of claim 7, wherein the one or more sensors are operable to transmit an optical beam, the one or more sensors triggered when one or more wafers protruding from the one or more cassettes disrupts the optical beam.

9. The system of claim 8, wherein the predetermined distance at which the detector is triggered is between three and five millimeters.

10. The system of claim 1, wherein the wafer press is proximate to a first wall of a wafer furnace, the wafer press extending longitudinally in a direction parallel to the first wall.

11. A method for eliminating wafer protrusion, comprising:
placing a plurality of wafers in one or more cassettes, each cassette configured to store a plurality of wafers in a stocker system;
placing the cassette on a shelf of the stocker system, the stocker system configured to receive a plurality of cassettes stacked vertically on a plurality of shelves;
activating a wafer press operable to apply a force to the wafers protruding from the one or more cassettes to reposition the wafers in the one or more cassettes.

12. The method of claim 11, further comprising:
coupling the wafer press to a cylinder; and
adjusting the pressure in the cylinder to change the location of the wafer press.

13. The method of claim 12, wherein an increase in pressure moves the wafer press away from the one or more cassettes and a decrease in pressure moves the wafer press toward the one or more cassettes, the wafer press operable to apply a force to the wafers protruding from the one or more cassettes when the pressure is decreased.

14. The method of claim 12, wherein the cylinder includes compressed Nitrogen gas.

15. The method of claim 12, wherein the wafer press comprises:
an extending arm coupling the wafer press to the cylinder; and
a press plate coupled to the extending arm with one or more springs, the press plate configured to apply a force in the horizontal direction to reposition the wafers protruding from the one or more cassettes.

16. The method of claim 11, further comprising activating the wafer press when one or more sensors are activated.

17. The method of claim 16, wherein the one or more sensors are activated when a cassette is placed on an associated shelf.

18. The method of claim 16, wherein the one or more sensors are activated when one or more wafers protrude a predetermined distance outside the one or more cassettes.

19. The method of claim 16, wherein the one or more sensors are operable to transmit an optical beam, the one or more sensors activated when one or more wafers protruding from the one or more cassettes disrupt the optical beam.

20. The method of claim 18, wherein the predetermined distance at which the one or more sensors is triggered is between three and five millimeters.

21. The method of claim 11, wherein the wafer press is proximate to a first wall of a wafer furnace, the wafer press extending longitudinally in a direction parallel to the first wall.
